(19) United States
(12) Patent Application Publication
(10) Pub. No.: US 2026/0247472 A1
(43) Pub. Date: Aug. 20, 2026

(54) METHOD AND APPARATUS FOR HANDLING RRC MESSAGE

(71) Applicant: SAMSUNG ELECTRONICS CO., LTD., Suwon-si (KR)

(72) Inventors: Sanjukta BISWAS, Bangalore (IN); Jajohn Mathew MATTAM, Bangalore (IN)

(21) Appl. No.: 19/643,512

(22) Filed: Apr. 9, 2026

Related U.S. Application Data
(63) Continuation of application No. PCT/KR2024/015414, filed on Oct. 11, 2024.

(30) Foreign Application Priority Data
Nov. 12, 2023 (IN) 202341068780
Sep. 26, 2024 (IN) 202341068780

(51) Int. Cl. H04W 76/27

(52) U.S. Cl. CPC H04W 76/27

(57) ABSTRACT

A method of the disclosure including: receiving, by a User Equipment (UE), a Medium Access Control-Control Element (MAC CE) from a gNodeB (gNB); performing, by the UE, a Lower-layer Triggered Mobility (LTM) from a source Distributed Unit (DU) to a target DU based on the received MAC CE; receiving, by the UE, the RRC message from the gNB, via the source DU, while performing the LTM from the source DU to the target DU; determining, by the UE, whether the RRC message is received within a specified time duration from the received MAC CE; and applying, by the UE, one or more reconfigurations associated with the RRC message based on a configuration associated with the target DU, wherein a configuration associated with the source DU is stored at the UE even after performing the LTM to the target DU.

### CROSS-REFERENCE TO RELATED APPLICATIONS

This application is a continuation of International Application No. PCT/KR2024/015414 designating the United States, filed on Oct. 11, 2024, in the Korean Ministry of Intellectual Property Receiving Office and claiming priority to Indian Provisional Patent Application No. 202341068780, filed on Nov. 12, 2023, and Indian Complete patent application No. 202341068780, filed on Sep. 26, 2024, in the Indian Patent Office, the disclosures of each of which are incorporated by reference herein in their entireties.

### BACKGROUND

### Field

The disclosure relates to the field of wireless communication networks, and for example, relates to a method and apparatus for handling a Radio Resource Control (RRC) message.

### Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems may serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In line with development of the communication systems, there is a need for handling a Radio Resource Control (RRC) message.

### SUMMARY

According to example embodiments, a method and an apparatus for handling a radio resource control (RRC) message may be provided. The method includes: receiving a Medium Access Control-Control Element (MAC CE) from a gNodeB (gNB; performing a lower-layer triggered mobility (LTM) from a source distributed unit (DU) to a target DU based on the MAC CE; receiving the RRC message from the gNB, via the source DU, while performing the LTM from the source DU to the target DU; determining whether the RRC message is received within a specified time duration from the MAC CE; applying reconfigurations associated with the RRC message based on a configuration associated with the target DU, wherein a configuration associated with the source DU is stored at a user equipment (UE) after performing the LTM to the target DU.

According to an example embodiment, a method for handling a Radio Resource Control (RRC) message is disclosed. The method includes: receiving, by a User Equipment (UE), a Medium Access Control-Control Element (MAC CE) from a gNodeB (gNB); performing, by the UE, a Lower-layer Triggered Mobility (LTM) from a source Distributed Unit (DU) to a target DU based on the received MAC CE; receiving, by the UE, the RRC message from the gNB, via the source DU, while performing the LTM from the source DU to the target DU; determining, by the UE, whether the RRC message is received within a specified time duration from the received MAC CE; applying, by the UE, one or more reconfigurations associated with the RRC message based on a configuration associated with the target DU, wherein a configuration associated with the source DU is stored at the UE even after performing the LTM to the target DU.

According to an example embodiment, an apparatus for handling a Radio Resource Control (RRC) message is disclosed. The apparatus includes: a memory; at least one processor, comprising processing circuitry, in communication with the memory, wherein at least one processor, individually and/or collectively, is configured to cause the apparatus to: receive a Medium Access Control-Control Element (MAC CE) from a gNodeB (gNB; perform a Lower-layer Triggered Mobility (LTM) from a source Distributed Unit (DU) to a target DU based on the received MAC CE; receive the RRC message from the gNB, via the source DU, while performing the LTM from the source DU to the target DU; determine whether the RRC message is received within a specified time duration from the received MAC CE; apply one or more reconfigurations associated with the RRC message based on a configuration associated with the target DU, wherein a configuration associated with the source DU is stored at the UE even after performing the LTM to the target DU.

According to an example embodiment, a method for handling a Radio Resource Control (RRC) message is disclosed. The method includes: receiving, by a User Equipment (UE) from a Control Unit (CU), the RRC message via a source Distributed Unit (DU; processing, by the UE, the received RRC message based on a configuration associated with the source DU; receiving, by the UE from a gNode (gNB), a Medium Access Control-Control Element (MAC CE) to perform a Lower-layer Triggered Mobility (LTM) from the source DU to a target DU during the processing of the RRC message; applying, by the UE, one or more reconfigurations based on the processed RRC message; transmitting, by the UE to the gNB, an indication indicating usage of the configuration of the source DU to apply the one or more reconfigurations associated with the RRC message.

According to an example embodiment, an apparatus for handling a Radio Resource Control (RRC) message is disclosed. The apparatus includes: a memory; at least one processor, comprising processing circuitry, in communication with the memory, wherein at least one processor, individually and/or collectively, is configured to cause the apparatus to: receive from a Control Unit (CU), the RRC message via a source Distributed Unit (DU; process the received RRC message based on configuration associated with the source DU; receive a Medium Access Control-Control Element (MAC CE) to perform a Lower-layer Triggered Mobility (LTM) from the source DU to a target DU during the processing of the RRC message; apply one or more reconfigurations based on the processed RRC message; transmit, to the gNB, an indication indicating usage of the configuration of the source DU to apply the one or more reconfigurations associated with the RRC message.

To further clarify the advantages and features of the present disclosure, a more detailed description will be rendered by reference to various example embodiments, which are illustrated in the appended drawings. It is appreciated that these drawings depict example embodiments of the disclosure and are therefore not to be considered limiting of its scope. The disclosure will be described and explained with additional specificity and detail with the accompanying drawings.

The present disclosure provides an effective and efficient method for handling the RRC message. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF THE DRAWINGS

The above and other aspects, features and advantages of certain embodiments of the present disclosure will be more apparent from the following detailed description, taken in conjunction with the accompanying drawings in which like reference numbers refer to like elements, and in which:

FIG. 1 is a diagram illustrating an example scenario depicting intermediate operations and steps performed in an overall handover procedure according to the prior art;

FIG. 2 is a block diagram illustrating an example of an inter-gNB-DU environment including a CU with multiple Dus according to the prior art;

FIG. 3 is a signal flow diagram illustrating an example procedure for a completion of cell change according to the prior art;

FIGS. 4A and 4B are diagrams illustrating a first example problem where a source DU detaches and an RRC message is delivered to the source DU with configuration associated with the source DU1 according to the prior art;

FIGS. 5A and 5B are diagrams illustrating a second example problem where an RRC entity delivers the RRC message and the UE performs the LTM procedure before processing the RRC message according to the prior art;

FIG. 6 is a block diagram illustrating an example configuration of an apparatus including a system for handling a Radio Resource Control (RRC) message, according to various example embodiments;

FIG. 7 is a flowchart illustrating an example method for handling the RRC message, according to various example embodiments;

FIG. 8 is a signal flow diagram illustrating the example method of FIG. 7 for handling the RRC message, according to various example embodiments;

FIG. 9 is a flowchart illustrating an example method for handling the RRC message, according to various example embodiments; and

FIG. 10 is a signal flow diagram illustrating the example method of FIG. 9 for handling the RRC message, according to various example embodiments.

Further, skilled artisans will appreciate that those elements in the drawings are illustrated for simplicity and may not have necessarily been drawn to scale. For example, the flowcharts illustrate the method in terms of steps involved to help to improve understanding of aspects of the present disclosure. Furthermore, in terms of the construction of the device, one or more components of the device may have been represented in the drawings by conventional symbols, and the drawings may illustrate details to aid in understanding the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various example embodiments and specific language will be used to describe the same. It should be understood at the outset that although illustrative implementations of various example embodiments of the present disclosure are illustrated below, the present disclosure may be implemented using any number of techniques, whether currently known or in existence. The present disclosure is not necessarily limited to the illustrative implementations, drawings, and techniques illustrated below, including the example design and implementation illustrated and described herein, but may be modified within the scope of the present disclosure.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with the embodiment being included in at least one embodiment of the present disclosure. Thus, appearances of the phrase “in an embodiment”, “in another embodiment” and similar language throughout this disclosure may, but do not necessarily, all refer to the same embodiment.

It is to be understood that as used herein, terms such as, “includes,” “comprises,” “has,” etc. are intended to refer to the one or more features or elements listed being within the element being defined, but the element is not necessarily limited to the listed features and elements, and that additional features and elements may be within the meaning of the element being defined.

The various example embodiments herein and the various features and advantageous details thereof are explained more fully with reference to the accompanying drawings and detailed in the following description. Descriptions of well-known components and processing techniques may be omitted to not unnecessarily obscure the disclosure with unnecessary detail. The various example embodiments described herein are not necessarily mutually exclusive, as various embodiments can be combined with one or more other embodiments to form new embodiments. The term “or” as used herein, refers to a non-exclusive or unless otherwise indicated. The examples used herein are intended merely to facilitate an understanding of ways in which the disclosure can be practiced. Accordingly, the examples should not be construed as limiting the scope of the disclosure.

Various embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits of a block may be implemented by dedicated hardware, by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. The blocks of the various embodiments may be physically combined into more complex blocks without departing from the scope of the disclosure.

The accompanying drawings are used to help easily understand various technical features and it should be understood that the example embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

With the advancements in wireless technology and communication systems, the demand for wireless data traffic has increased since the deployment of 4th-generation (4G) networks. To meet such demand for wireless data traffic, efforts have been made to develop 5th-generation (5G) networks.

The 5G networks have emerged as the next generation of cellular networks, offering higher data speeds, lower latency, and increased capacity compared to previous generations. To further enhance the capabilities of 5G, the 3rd Generation Partnership Project (3GPP) proposed a Lower-layer Triggered Mobility (LTM) procedure. In particular, the LTM is a procedure where a gNodeB (gNB) (5G base station) receives Layer 1 (L1) measurement reports from a User Equipment (UE). The LTM is used for handover. Further, the gNB then changes UEs' serving cell(s) by a cell switch command through a Medium Access Control (MAC) Control Element (MAC-CE), which indicates an LTM candidate cell on those L1 measurement basis. For this, the gNB previously prepares one or multiple candidate cells and provides the LTM candidate cell configurations to the UE through an RRC signalling message. Thereafter, a cell switch is triggered, by selecting the indicated LTM candidate cell configuration as the target configuration by the gNB.

An LTM candidate cell configuration can only be added, modified, and released by the network via RRC signaling. The LTM procedure can be used to reduce the mobility latency of a current baseline Handover. The LTM supports both intra-gNB-DU and intra-gNB-Control Unit (CU) inter-gNB-Distributed Unit (DU) mobility. The LTM supports inter-frequency mobility including mobility to an inter-frequency cell that is not a current serving cell. The procedure of L1/L2-based inter-cell mobility applies, for example, and without limitation, to the following scenarios mentioned below:
Standalone, CA, and NR-DC cases with serving cell change within one CG.
Intra-DU case and intra-CU inter-DU case.
Both intra-frequency and inter-frequency.
Both FR1 and FR2.
Source and target cells may be synchronized or non-synchronized.

An LTM signalling procedure between the UE and the gNB may be performed as illustrated below:
The UE sends a measurement report message to the gNB. The gNB decides to use LTM and initiates candidate cell(s) preparation.
The gNB transmits an RRC Reconfiguration message to the UE including the LTM candidate cell configurations of one or multiple candidate cells.
The UE stores the LTM candidate cell configurations and transmits an RRCReconfigurationComplete message to the gNB.
The UE may perform DL synchronization with candidate cell(s) before receiving the cell switch command. The UE may perform early TA acquisition with candidate cell(s) before receiving the cell switch command.
The UE performs L1 measurements on the configured candidate cell(s) and transmits lower-layer measurement reports to the gNB.
The gNB decides to execute a cell switch to a target cell and transmits a MAC CE triggering cell switch by including the candidate configuration index of the target cell. The UE switches to the configuration of the target cell.
The UE performs a random-access procedure towards the target cell if the cell switch needs to include performing a random-access procedure.
The UE completes the LTM cell switch procedure by sending an RRCReconfigurationComplete message to the target cell. For RACH-based LTM, the UE considers that the LTM procedure is completed when the random-access procedure is completed. For RACH-less LTM, the UE considers that the LTM procedure is completed when the UE determines that the network has successfully received its first UL data.

Considering the above-disclosed LTM signalling procedure, factors contributing to an overall handover procedure are measurement evaluation, reporting, reconfiguration, and signalling performed by a Radio Resource Control (RRC) entity.

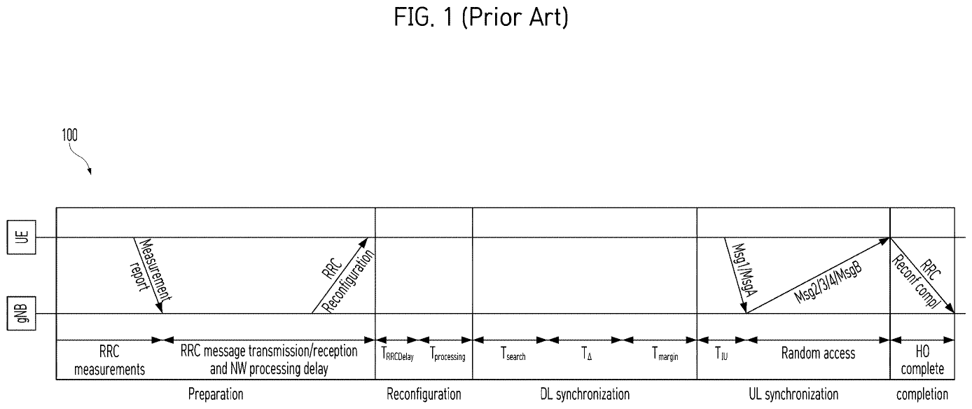

FIG. 1 is a diagram illustrating an example scenario 100 depicting intermediate operations and steps performed in the overall handover procedure according to the prior art. Currently, and especially in a case of a PCell change, a significant proportion of the measurements evaluation, reporting, reconfiguration, and signalling needs to be performed by the RRC. In particular, since mobility decisions are taken by the RRC entity of the CU as part of an implementation of the gNB, the UE measurements are reported by the RRC entity to the CU. In addition to that, the measurement report/event handling performed in RRC is designed to provide some level of stability (e.g., via L3 filtering) and robustness (e.g., via RLC retransmissions) when reporting measurements to be used for mobility decisions, where an interruption time shall be less than a Tᵢₙₜₑᵣᵣᵤₚₜ. The interruption time is the time between the end of the last TTI containing an RRC command on an old (e.g., source cell) PDSCH and the time at which the UE starts transmission of a new PRACH, excluding an RRC procedure delay. When an intra-frequency or inter-frequency handover is performed, the interruption time shall be less than the Tᵢₙₜₑᵣᵣᵤₚₜ, given by equation (1):

$${T}_{interrupt} = {T}_{search} + {T}_{IU} + {T}_{processing} + {T}_{Δ} + {T}_{margin ms} \qquad ( 1 )$$

Where:
T_{search} is the time required to search the target cell when the target cell is not already known when the handover command is received by the UE,
T_{Δ} is time for fine time tracking and acquiring full-timing information of the target cell,
T_{processing} is time for UE processing,
T_{margin} is the time for SSB post-processing, and
T_{IU} is the interruption uncertainty in acquiring the first available PRACH occasion in the new cell.
The T_{processing} can be up to 20 ms whereas the T_{margin} can be up to 2 ms.

However, there can be multiple issues with the LTM procedure in an inter-gNB-DU scenario.

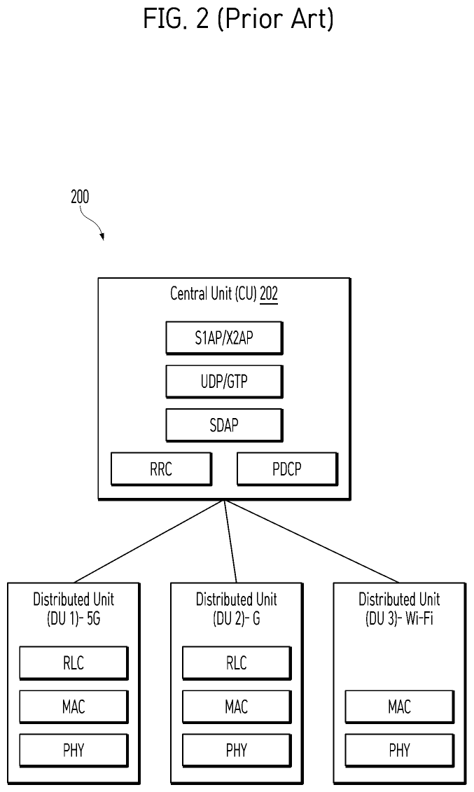

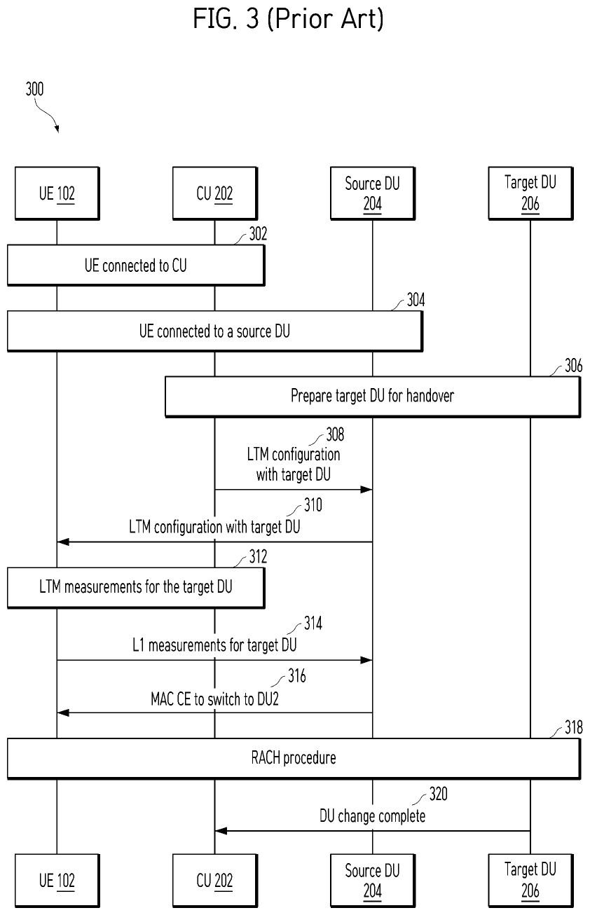

FIG. 2 is a block diagram illustrating an example of an inter-gNB-DU environment 200 including a CU 202 with multiple Dus according to the prior art. As shown in FIG. 2, the CU 202 can have multiple DUs (such as DU1, DU2, . . . . DUn) with different configurations and technology. The CU 202 includes upper layers, such as RRC and Package Data Convergence Protocol (PDCP). Further, the DU includes lower layers, for example, PHY, MAC, and RLC. In the case of lower-layer mobility or handover, a configuration of the upper layers remains the same since mobility happens between one DU (for example, source DU1) and another DU (for example, DU2). Thus, while performing the LTM procedure, the upper layers do not get any notification immediately unlike the case of baseline handover, where the handover itself is performed by the RRC entity or the upper layers. This creates a problem or a gap which is explained in greater detail below with reference to FIGS. 3, 4A, 4B, 5A and 5B.

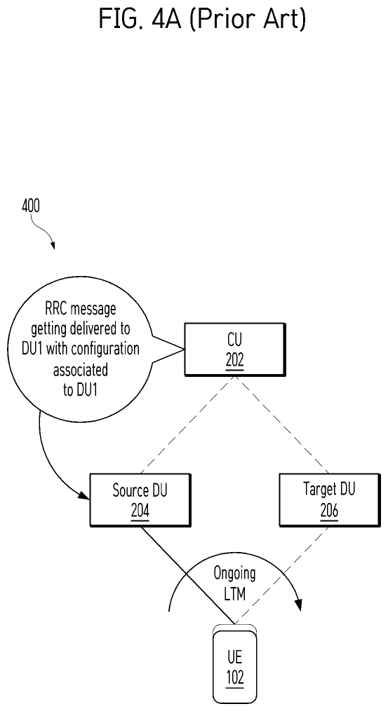

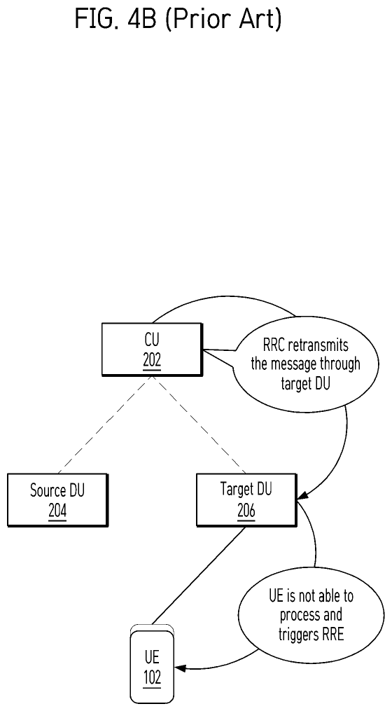

FIG. 3 is a signal flow diagram illustrating an example procedure 300 for completion of cell change according to various embodiments. At step 302, the UE 102 gets connected to the CU 202. Further, at step 304, the UE 102 gets connected with the source DU 204. At step 306, the CU 202 prepares the target DU 206 for handover. At 308, the LTM configuration request is sent from CU to the source DU 204 which is then sent to the UE 102 at step 310. Further, at step 312, LTM measurements are performed for the target DU 206. Further, at step 314, L1 measurement is sent to source DU 204. At step 316, a serving cell e.g., the source DU 204 sends a Medium Access Control-Control Element (MAC CE) to the UE 102 for triggering the cell change to the target DU 206. Further, at step 318, the random-access channel (RACH) procedure is performed. At step 320, the cell change is completed to the target DU 206, and the UE 102 detaches from the source DU 204 to perform LTM which results in a problem discussed in greater detail below with reference to FIGS. 4A and 4B.

FIGS. 4A and 4B are diagrams illustrating a first example problem 400 where the source DU 204 detaches and an RRC message is delivered to the source DU 204 with configuration associated with the source DU 204 according to the prior art. As shown in FIG. 4A, the CU 202 is sending the RRC message to the source DU 204, and simultaneously an independent LTM process is taking place, so before the RRC message can be processed, the UE 102 performs the LTM, detaches from the source DU 204, and attaches to the target DU 206.

Further, the source DU 204 may send a notification of LTM triggering to the CU 202. However, before the CU 202 receives the notification sent by the source DU 204 the CU 202 may send an RRC message to the UE 102 via the DU 204 as a container in an F1AP message. As illustrated in FIG. 4B, since the UE 102 has performed the LTM procedure to the target DU 206, now network (NW) re-transmits the RRC message through the target DU 206 which contains configuration specific to the source DU 204. Thus, the target DU 206 is not able to process the RRC message.

Furthermore, after the delivery failure of the RRC message, if the RRC message is re-transmitted to the UE 102 via the target DU 206 (e.g., once the CU 202 is informed about the mobility to the target DU 206), then if the message contains configurations specific to the source DU 204, the UE 102 may fail to apply the outdated RRC configuration since references an old serving cell group and the UE 102 connects to a new serving cell group. This triggers connection re-establishment by the UE 102.

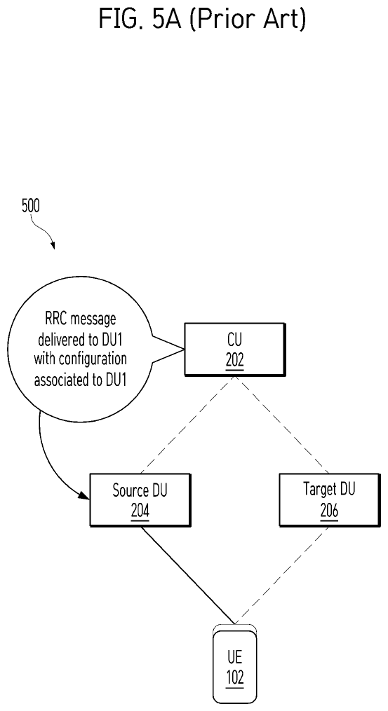

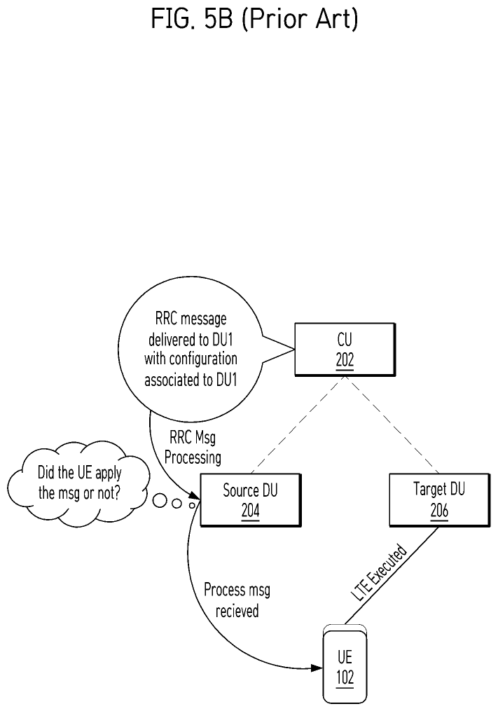

FIGS. 5A and 5B are diagrams illustrating a second example problem 500 where the RRC entity delivers the RRC message and the UE 102 performs the LTM procedure before processing the RRC message according to the prior art. Referring to FIG. 5A, there could be a scenario where the RRC message is delivered to the UE 102 via source DU 204 (serving), meanwhile, the MAC CE is sent from the serving cell, and the UE 102 performs the LTM procedure. This creates confusion for both the UE 102 and the gNB on what to do with the processed RRC message. If the UE 102 does not apply the RRC message first and performs the LTM procedure, then UE may not be able to figure out if the RRC message was related to the source DU 204 (old serving cell) or the target DU 206 (current serving cell). Thus, the gNB also won't be able to determine if the UE 102 applied the RRC message and then performed the LTM procedure, as no message was received, or if the UE 102 performed the LTM process first and discarded the RRC message as illustrated in FIG. 5B.

In brief, when the UE 102 receives the RRC message which is retransmitted over the target DU 206, and if the RRC message contains configurations specific to the source DU 204, the UE 102 may fail to apply the outdated RRC configuration since it references the old serving cell group and the UE 102 connects to a new serving cell group. This triggers connection re-establishment by the UE 102. If the LTM (MAC CE to switch) is received by the UE 102 while processing the RRC message, there is no defined mechanism for the behavior of the UE 102.

Therefore, there lies a need for an improved method and apparatus that can address and overcome the problem in the existing-state-of-the-art.

The drawbacks/difficulties/disadvantages/limitations of the existing state-of-the-art explained in the background section are simply for explanatory purposes. One skilled in the art would understand that this disclosure and below mentioned description may also address other problems or address other drawbacks/disadvantages.

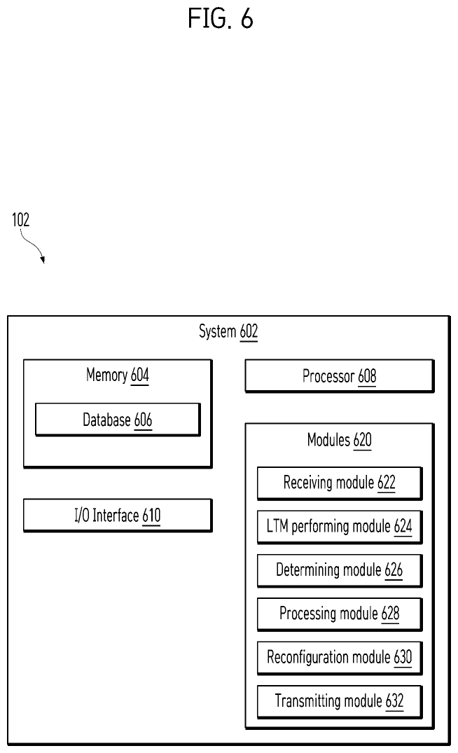

FIG. 6 is a block diagram illustrating an example configuration of an example apparatus 102 including a system 602 for handling a Radio Resource Control (RRC) message, according to various example embodiments. In an example embodiment, the apparatus 102 may be referred to as User Equipment (UE) (102). In a non-limiting example, the UE 102 may include a smartphone, a laptop computer, a desktop computer, a Personal Computer (PC), a notebook, a tablet, a smartwatch, or the like. In an embodiment, the system 602 may include a memory 604 including a database 606, a processor (e.g., including processing circuitry) 608 communicatively coupled with the memory 604, an Input/Output (I/O) interface (e.g., including circuitry) 610, and a plurality of modules (e.g., including various circuitry and/or executable program instructions) 620.

In an embodiment, the memory 604 is configured to store instructions executable by the processor 608. In an embodiment, the memory 604 communicates via a bus within the system 602. The memory 604 includes but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In an example, the memory includes a cache or random-access memory (RAM) for the processor 608. In various examples, the memory 604 is separate from the processor 608 such as a cache memory of a processor, the system memory, or other memory. The memory 604 may include an external storage device or the memory 606 is for storing data. The memory 604 is operable to store instructions executable by the processor 608. The functions, acts, or tasks illustrated in the figures or described are performed by the programmed processor for executing the instructions stored in the memory 604. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies include multiprocessing, multitasking, parallel processing, and the like.

As a non-limiting example, the processor 608 may include various processing circuitry and may be a single processing unit or a set of units each including multiple computing units. The processor 608 may be implemented as one or more microprocessors, microcomputers, microcontrollers, digital signal processors, central processing units, state machines, logic circuitries, and/or any devices that manipulate signals based on operational instructions (computer-readable instructions) stored in the memory 604. Among other capabilities, the processor 608 may be configured to fetch and execute computer-readable instructions and data stored in the memory 604. The processor 608 includes one or a plurality of processors. The plurality of processors is further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). Thus, the processor 608 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 608 may be disposed in communication with one or more Input/Output (I/O) devices via the Input/Output (I/O) interface 610. The I/O interface 610 employs communication Code-Division Multiple Access (CDMA), High-Speed Packet Access (HSPA+), Global System for Mobile communications (GSM), Long-Term Evolution (LTE), WiMax, and the like, etc. In an embodiment, the I/O interface 610 employs ethernet, industrial wireless Local Area Network (LAN), Process Field Bus (PROFIBUS), Actuator Sensor (AS) Interface, and the like.

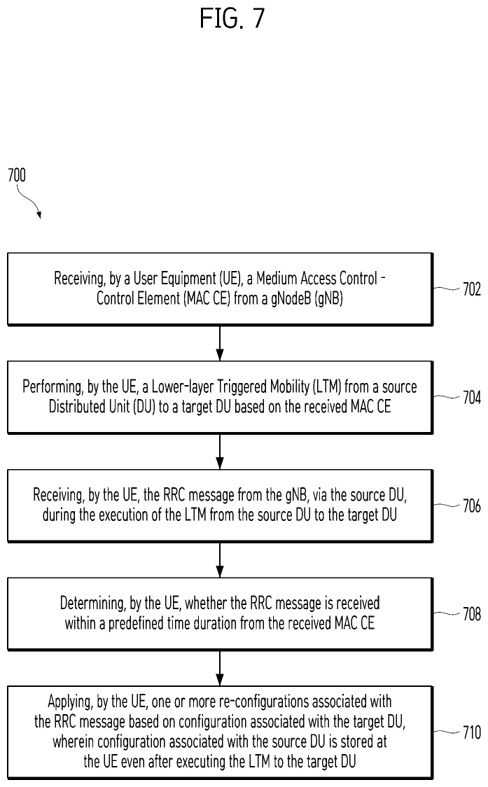

The plurality of modules 620 may include the one or more instructions that may be executed to cause the system 602, for example, the processor 608 of the system 602, to execute the one or more instructions. The plurality of modules 620 may include a receiving module 622, an LTM performing module 624, a determining module 626, a processing module 628, a reconfiguration module 630, and a transmitting module 632. In an embodiment, the receiving module 622, the LTM performing module 624, the determining module 626, the processing module 628, the reconfiguration module 630, and the transmitting module 632 may be in communication with each other. The plurality of modules 620 may be configured to perform various operations or steps that may be discussed and explained in greater detail below with reference to FIGS. 7, 8, 9 and 10.

FIG. 7 is a flowchart illustrating an example method 700 for handling the RRC message, according to various example embodiments. In an embodiment, the method 700 may be a computer-implemented method 700.

At step 702, the method 700 may include receiving, via the receiving module 622, a Medium Access Control-Control Element (MAC CE) from a gNodeB (gNB). In an embodiment, the MAC CE herein may refer to a component of the Medium Access Control (MAC) layer in wireless communication networks. The MAC CE may convey control information between the UE 102 and a base station e.g., the gNodeB (gNB).

At step 704, the method 700 may include performing, via the LTM performing module 624, a Lower-layer Triggered Mobility (LTM) from a source Distributed Unit (DU) (204) to a target DU 206 based on the received MAC CE.

At step 706, the method 700 may include receiving, via the receiving module 622, the RRC message from the gNB, via the source DU 204, while performing the LTM from the source DU 204 to the target DU 206. For example, the RRC message may be received by a Control Unit (CU) associated with the gNB. In an embodiment, the RRC message refers to a message in the Radio Resource Control (RRC) protocol for managing radio resources between the UE 102 and the network. In an example scenario, the RRC message may include an RRC connection request, an RRC connection setup, an RRC connection release, and an RRC configuration.

At step 708, the method 700 may include determining, via the determining module 626, whether the RRC message may be received within a predefined (e.g., specified) time duration from the received MAC CE. In an example scenario, the determining module 626 may be configured to determine whether the RRC message is received within the predefined time duration of 40 to 80 milliseconds.

At step 710, the method 700 may include applying, via the reconfiguration module 630, one or more reconfigurations associated with the RRC message based on a configuration associated with the target DU 206. In an embodiment, the configuration associated with the source DU 204 may be stored in the database of the UE 102 even after performing the LTM to the target DU 206. For example, the UE 102 may store the configuration of the source DU 204 even after the UE 102 is detached from the source DU 204 and attaches to the target DU 206.

In an embodiment, the method 700 may include a step of transmitting, via the transmitting module 632, to the target DU 206, an indication indicating a successful reconfiguration associated with the received RRC message based on usage of the configuration associated with the target DU 206.

In an embodiment, the one or more reconfigurations associated with the RRC message may fail when applied with the configuration associated with the target DU 206. Therefore, in response to the failure of the applied one or more reconfigurations, the method 700 may include a step of applying, via the reconfiguration module 630, the one or more reconfigurations associated with the RRC message based on the stored configuration associated with the source DU 204.

In an embodiment, the method 700 may include a step of transmitting, via the transmitting module 632 to the source DU 204, the indication indicating a successful reconfiguration associated with the received RRC message based on usage of the stored configuration associated with the source DU 204.

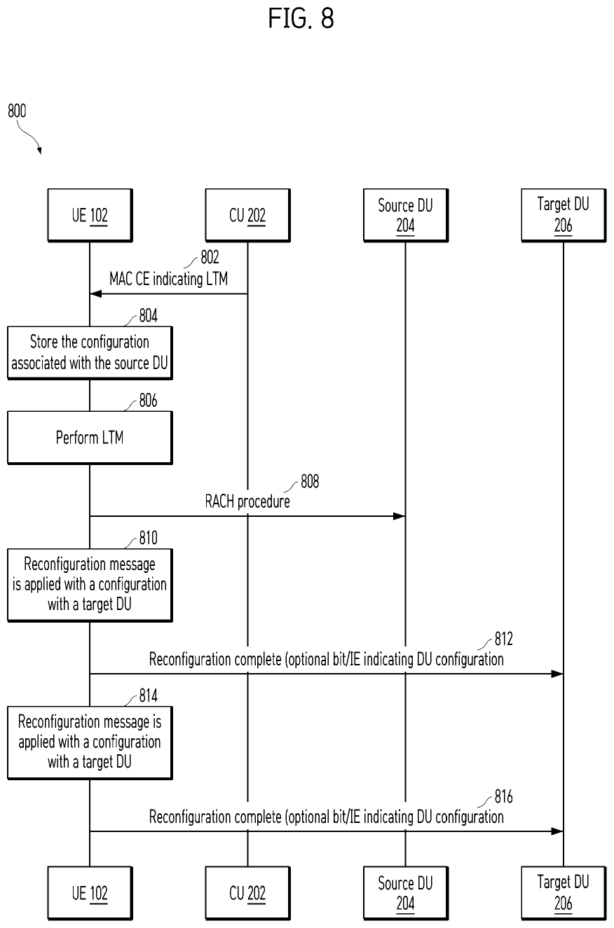

FIG. 8 is a signal flow diagram 800 illustrating the example operations of FIG. 7 for handling the RRC message, according to various example embodiments. In an example scenario, at step 802, the MAC CE request is received from the source DU 204. Further, at step 804, the configuration associated with the source DU 204 may be stored in the database of the UE 102. Further, at step 806, the UE 102 may perform the LTM which may initiate a RACH procedure for the target DU 206 as illustrated in step 808. Further, at step 810, the RRC message is received from the CU 202 before a predefined time duration. At step 810, the re-configuration message may be applied to the configuration associated with the target DU 206 and transmit the complete reconfiguration message to the target DU 206 at step 812. Further, if the reconfiguration fails, then at step 814, the UE 102 attempts to apply the reconfiguration message using the stored configuration associated with the source DU 204, and the reconfiguration complete message to the target DU 206 at step 816. In an embodiment, while sending the reconfiguration complete message, the UE 102 may include an IE or bit to indicate the DU from which the configuration is applied, and a network (NW) may take further actions upon application of the configuration.

According to the present disclosure, a method for handling the RRC message is disclosed.

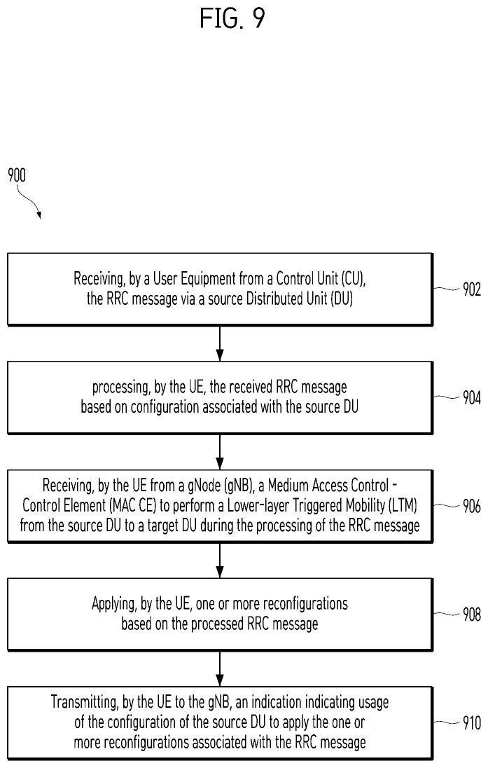

FIG. 9 is a flowchart illustrating an example method 900 for handling the RRC message, according to various example embodiments.

At step 902, the method 900 may include receiving, from the CU 202, the RRC message via the source DU 204. At step 904, the method 900 may include processing, via the processing module 628, the received RRC message based on the configuration associated with the source DU 204.

At step 906, the method 900 may include receiving, via the receiving module 622 from the gNode (gNB), a Medium Access Control-Control Element (MAC CE) to perform the LTM from the source DU 204 to the target DU 206 during the processing of the RRC message.

At step 908, the method 900 may include applying, via the reconfiguration module 630, the one or more reconfigurations based on the processed RRC message. At step 910, the method may include transmitting, via the transmitting module 632 to the gNB, an indication indicating usage of the configuration of the source DU 204 to apply the one or more reconfigurations associated with the RRC message. In an embodiment, the configuration associated with the source DU 204 may be stored in the database.

In an embodiment, when the processing of the received RRC message failed with the configuration of the source DU 204. Therefore, in response to the failure, the method 900 may include a step of processing the received RRC message based on the configuration associated with the target DU 206 when the LTM may be performed.

In an embodiment, the method may include a step of transmitting, via the transmitting module to one of the source DU 204 or the target DU 206, an indication indicating a successful reconfiguration associated with the received RRC message based on usage of the stored configuration associated with the source DU 204 or the configuration associated with the target DU 206, respectively.

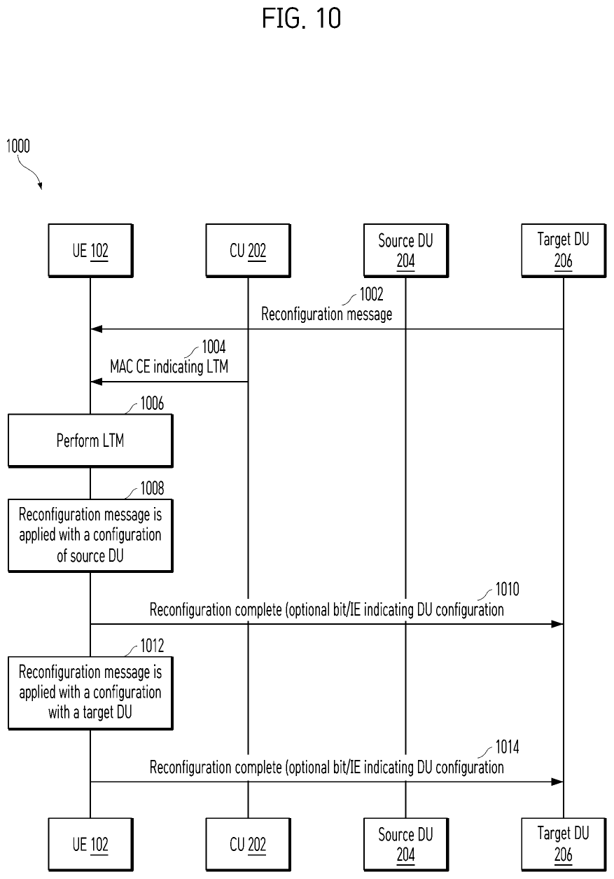

FIG. 10 is a signal flow diagram 1000 illustrating the example operations of FIG. 9 for handling the RRC message, according to various example embodiments.

In an example scenario, at step 1002, the RRC message is received from the CU 202. Further, at step 1004, the MAC CE request is received from the source DU 204. Further, the at step 1006, the UE 102 may perform the LTM. Further, at step 1008, the re-configuration message may be applied with a configuration associated with the source DU 204, and send the reconfiguration complete message to the target DU 206 at step 1010. Further, if the reconfiguration fails, then at step 1012, the UE 102 attempts to apply the reconfiguration message using the configuration associated with the target DU 206, and send the reconfiguration complete message to the target DU 206 at step 1014. In an embodiment, while sending the reconfiguration complete message, the UE 102 may include an IE or bit to indicate the DU from which the configuration is applied, and an NW may take further actions upon application of the configuration.

The above-disclosed example method helps in providing a better user experience in terms of getting unnecessary lower-layer failures during ongoing LTM handovers. According to the above-disclosed example method the UE 102 will not perform any unnecessary RRC re-establishment which causes an interruption in service and thereby provides the better user experience. The above-disclosed example methods also help in saving power to perform multiple RRC re-establishments. The optional bit/IE to indicate the DU configured with the applied message as disclosed in the above example methods further helps the NW to know on which DU the RRC message is applied.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the concept as taught herein. The drawings and the forgoing description give examples of various embodiments. Those skilled in the art will appreciate that one or more of the described elements may well be combined into a single functional element. Certain elements may be split into multiple functional elements. Elements from one embodiment may be added to another embodiment.

Thus, while the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method for handling a Radio Resource Control (RRC) message, comprising:
receiving, by a User Equipment (UE), a Medium Access Control-Control Element (MAC CE) from a gNodeB (gNB);
performing, by the UE, a Lower-layer Triggered Mobility (LTM) from a source Distributed Unit (DU) to a target DU based on the received MAC CE;
receiving, by the UE, the RRC message from the gNB, via the source DU, while performing the LTM from the source DU to the target DU;
determining, by the UE, whether the RRC message is received within a specified time duration from the received MAC CE; and
applying, by the UE, one or more reconfigurations associated with the RRC message based on a configuration associated with the target DU,
wherein a configuration associated with the source DU is stored at the UE after performing the LTM to the target DU (206).

2. The method as claimed in claim 1, wherein in response to a failure of the applied one or more reconfigurations associated with the RRC message based on the configuration associated with the target DU, the method comprises:
applying, by the UE, the one or more reconfigurations associated with the RRC message based on the stored configuration associated with the source DU.

3. The method as claimed in claim 1, further comprising:
transmitting, to one of the source DU or the target DU, an indication indicating a successful reconfiguration associated with the received RRC message based on usage of the stored configuration associated with the source DU or the configuration associated with the target DU, respectively.

4. The method as claimed in claim 1, wherein the RRC message is received from a Control Unit (CU) associated with the gNB.

5. A method for handling a Radio Resource Control (RRC) message, comprising:
receiving, by a User Equipment (UE) from a Control Unit (CU), the RRC message via a source Distributed Unit (DU);
processing, by the UE, the received RRC message based on a configuration associated with the source DU;
receiving, by the UE from a gNode (gNB), a Medium Access Control-Control Element (MAC CE) to perform a Lower-layer Triggered Mobility (LTM) from the source DU to a target DU during the processing of the RRC message;
applying, by the UE, one or more reconfigurations based on the processed RRC message; and
transmitting, by the UE to the gNB, an indication indicating usage of the configuration of the source DU to apply the one or more reconfigurations associated with the RRC message.

6. The method as claimed in claim 5, wherein in response to a failure of processing of the received RRC message based on the configuration associated with the source DU, the method comprises:
processing the received RRC message based on a configuration associated with the target DU based on the LTM being performed.

7. The method as claimed in claim 5, further comprising:
transmitting, to one of the source DU or the target DU, an indication indicating a successful reconfiguration associated with the received RRC message based on usage of the stored configuration associated with the source DU or the configuration associated with the target DU, respectively.

8. An apparatus for handling a Radio Resource Control (RRC) message, comprising:
a memory; and
at least one processor, comprising processing circuitry, in communication with the memory, wherein at least one processor, individually and/or collectively, is configured to cause the apparatus to:
receive a Medium Access Control-Control Element (MAC CE) from a gNodeB (gNB);
perform a Lower-layer Triggered Mobility (LTM) from a source Distributed Unit (DU) to a target DU based on the received MAC CE;
receive the RRC message from the gNB, via the source DU, while performing the LTM from the source DU to the target DU;
determine whether the RRC message is received within a specified time duration from the received MAC CE; and
apply one or more reconfigurations associated with the RRC message based on a configuration associated with the target DU,
wherein a configuration associated with the source DU is stored at the UE after performing the LTM to the target DU.

9. The apparatus as claimed in claim 8, wherein in response to a failure of the applied one or more reconfigurations associated with the RRC message based on the configuration associated with the target DU, at least one processor, individually and/or collectively, is configured to cause the apparatus to:
apply the one or more reconfigurations associated with the RRC message based on the stored configuration associated with the source DU.

10. The apparatus as claimed in claim 8, wherein at least one processor, individually and/or collectively, is configured to cause the apparatus to:
transmit, to one of the source DU or the target DU, an indication indicating a successful reconfiguration associated with the received RRC message based on usage of the stored configuration associated with the source DU or the configuration associated with the target DU, respectively.

11. The apparatus as claimed in claim 8, wherein the RRC message is received from a Control Unit (CU) associated with the gNB.

12. An apparatus for handling a Radio Resource Control (RRC) message, comprising:
a memory; and
at least one processor, comprising processing circuitry, in communication with the memory, wherein at least one processor, individually and/or collectively, is configured to cause the apparatus to:
receive from a Control Unit (CU), the RRC message via a source Distributed Unit (DU);
process the received RRC message based on a configuration associated with the source DU,
receive, from a gNode (gNB), a Medium Access Control-Control Element (MAC CE) to perform a Lower-layer Triggered Mobility (LTM) from the source DU to a target DU during the processing of the RRC message;
apply one or more reconfigurations based on the processed RRC message; and
transmit, to the gNB, an indication indicating usage of the configuration of the source DU to apply the one or more reconfigurations associated with the RRC message.

13. The apparatus as claimed in claim 12, wherein in response to a failure of processing of the received RRC message based on the configuration associated with the source DU, at least one processor, individually and/or collectively, is configured to cause the apparatus to:
process the received RRC message based on a configuration associated with the target DU based on the LTM being performed.

14. The apparatus as claimed in claim 12, wherein at least one processor, individually and/or collectively, is configured to cause the apparatus to:
transmit, to one of the source DU or the target DU, an indication indicating a successful reconfiguration associated with the received RRC message based on usage of the configuration associated with the source DU or the configuration associated with the target DU, respectively.
